(19) United States
(12) Patent Application Publication
(10) Pub. No.: US 2008/0075252 A1
(43) Pub. Date: Mar. 27, 2008

(54) Intercom having a hand-driven power generator unit

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/515,726

(22) Filed: Sep. 6, 2006

(51) Int. Cl. H04M 1/00

(52) U.S. Cl. 379/159

(57) ABSTRACT

An intercom is disclosed to include a housing houses a transmitter receiver control circuit board, and a hand-driven power generator unit, which has a speed-change gear set, a crank handle pivoted to the housing for operation by a person to rotate the speed-change gear set, and a dynamo coupled to the speed-change gear set and driven to generate electricity for the transmitter receiver control circuit board upon rotation of the speed-change gear set by a person.

### BACKGROUND OF THE INVENTION

1. Field of the Invention

The present invention relates to an intercom and more particularly, to an intercom having a hand-driven power generator unit.

2. Description of the Related Art

Conventional intercoms commonly use a battery to provide the necessary working voltage. When the power of the battery of an intercom is low, the battery must be immediately replaced. In case no new battery is available, the intercom becomes not operable. Therefore, a person must carry a certain number of battery cells when using an intercom in a high mountain.

### SUMMARY OF THE INVENTION

The present invention has been accomplished under the circumstances in view. It is therefore the main object of the present invention to provide an intercom, which has a hand-driven power generator unit that can be driven by hand to generate electricity for the working of the intercom. To achieve this and other objects of the present invention, the a housing houses a transmitter receiver control circuit board, and a hand-driven power generator unit, which has a speed-change gear set, a crank handle pivoted to the housing for operation by a person to rotate the speed-change gear set, and a dynamo coupled to the speed-change gear set and driven to generate electricity for the transmitter receiver control circuit board upon rotation of the speed-change gear set by a person.

### BRIEF DESCRIPTION OF THE DRAWINGS

FIG. 1 is an exploded view of an intercom according to the present invention.

FIG. 2 is a system block diagram of the intercom according to the present invention.

### DETAILED DESCRIPTION OF THE PREFERRED EMBODIMENT

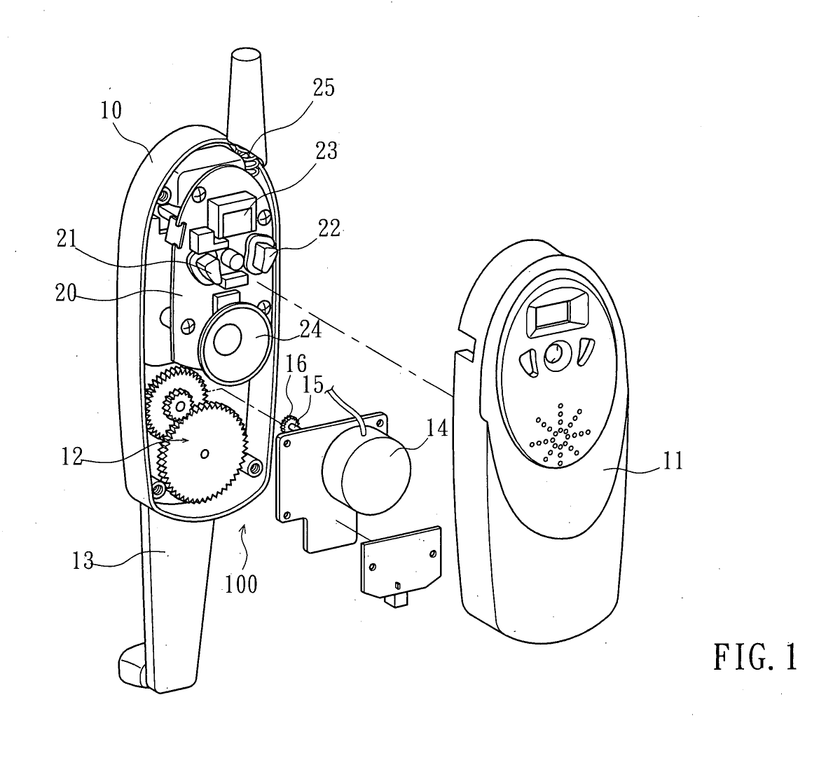

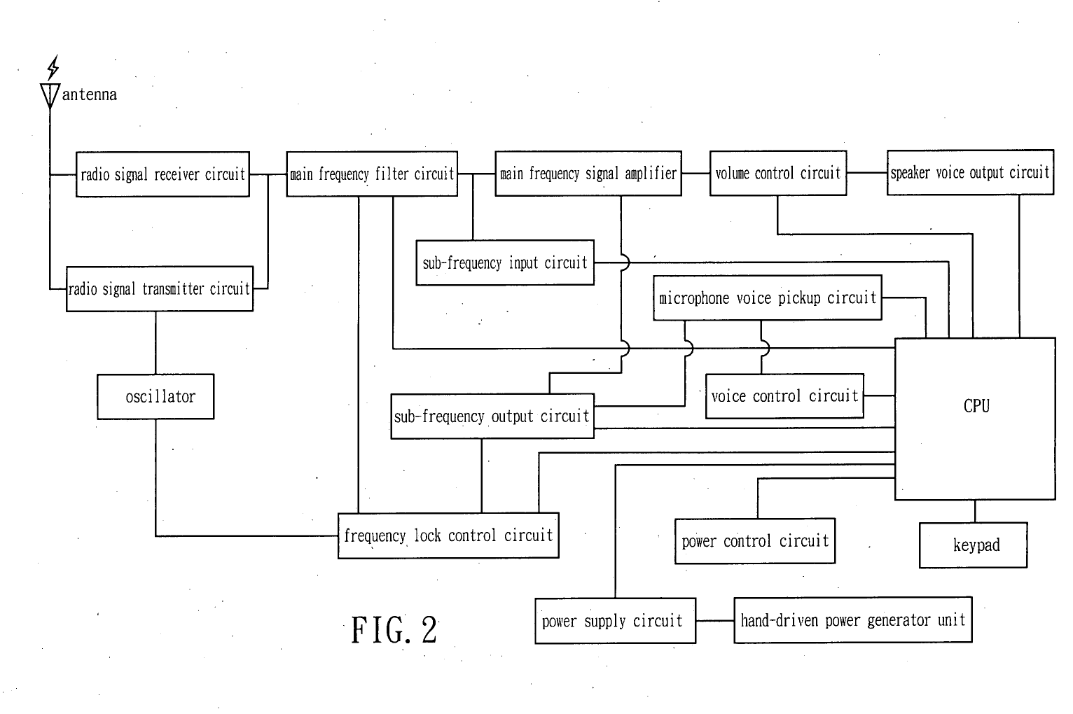

Referring to FIGS. 1 and 2, an intercom in accordance with the present invention is shown comprising a housing 10 covered with a cover shell 11. The housing 10 houses a transmitter receiver control circuit board 20 and a hand-driven power generator unit 100. The hand-driven power generator unit 100 is comprised of a speed-change gear set 12, a crank handle 13, and a dynamo 14.

The crank handle 13 is coupled to the speed-change gear set 12. The dynamo 14 has an input shaft 15, and a pinion 16 fixedly mounted on the input shaft 15 and meshed with the speed-change gear set 12. Therefore, the user can operate the crank handle 13 to drive the speed-change gear set 12, thereby causing the dynamo 14 to generate electricity for the working of the transmitter receiver control circuit board 20. The transmitter receiver control circuit board 20 comprises a CPU (Central Processing Unit), a radio signal receiver circuit, a radio signal transmitter circuit, an oscillator, a main frequency filter circuit, a main frequency signal amplifier, a sub-frequency input circuit, a sub-frequency output circuit, a frequency lock control circuit, a volume control circuit, a speaker voice output circuit, a microphone voice pickup circuit, a voice control circuit, a power control circuit, a power supply circuit, a keypad, and an antenna.

When using the intercom to talk to another intercom at a remote site, press “TALK” key 22 and then speak to microphone 23, so that the microphone voice pickup circuit and voice control circuit of the microphone 23 transmit the user's voice to the CPU. At the same time, the sub-frequency input circuit and the sub-frequency output circuit output a signal to the CPU. The CPU synthesizes the signals and then outputs the synthesized signal to the frequency lock control circuit, which locks the frequency, and then the oscillator, causing the oscillator to generate an oscillation signal, which is then transmitted into the air by the radio signal transmitter circuit via the antenna for receiving by an external intercom.

Further, when the antenna 25 receives a radio signal from an external intercom, the radio signal receiver circuit transmits the radio signal from the antenna 25 to the main frequency filter circuit to remove noises, and then the main frequency filter circuit sends the filtered signal through the frequency lock control circuit to the CPU for processing, and then the CPU outputs the processed signal to the main frequency amplifier circuit for amplification, and then the main frequency amplifier circuit outputs the amplified signal to the volume control circuit for volume control and to the speaker voice output circuit of the speaker 24 for output. Further, the user can operate the volume control key 21 to regulate the volume of the output voice.

Further, as stated above, the user can operate the crank handle 13 to drive the speed-change gear set 12, thereby causing the dynamo 14 to generate electricity, which is outputted to the power supply circuit of the transmitter receiver control circuit board 20. The power supply circuit of the transmitter receiver control circuit board 20 is comprised of a rectifier and a storage battery. The rectifier rectifies AC power supply from the hand-driven power generator unit 100 into DC power supply to charge the storage battery. Further, the power control circuit controls the voltage of the output power from the storage battery to the transmitter receiver control circuit board 20.

A prototype of intercom having a hand-driven power generator unit has been constructed with the features of FIGS. 1 and 2. The intercom having a hand-driven power generator unit functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An intercom comprising:
a housing covered with a cover shell;
a transmitter receiver control circuit board mounted inside said housing, said transmitter receiver control circuit board comprising a CPU (Central Processing Unit), a radio signal receiver circuit, a radio signal transmitter circuit, an oscillator, a main frequency filter circuit, a main frequency signal amplifier, a sub-frequency input circuit, a sub-frequency output circuit, a frequency lock control circuit, a volume control circuit, a speaker voice output circuit, a microphone voice pickup circuit, a voice control circuit, a power control circuit, a power supply circuit, a keypad, and an antenna; and
a hand-driven power generator unit mounted inside said housing and adapted to generate electricity for said transmitter receiver control circuit board, said hand-driven power generator comprising a speed-change gear set, a crank handle pivoted to said housing for operation by a person to rotate said speed-change gear set, and a dynamo coupled to said speed-change gear set and rotatable by said speed-change gear set to generate electricity and to output generated electricity to said transmitter receiver control circuit board.
